(19) United States
(12) Patent Application Publication
(10) Pub. No.: US 2025/0377529 A1
(43) Pub. Date: Dec. 11, 2025

(54) Microscope and method of microscopy for examining a sample

(71) Applicant: Carl Zeiss Microscopy GmbH, Jena (DE)

(72) Inventors: Richard Hollinger, Jena (DE); Ralf Netz, Jena (DE); Ingo Kleppe, Jena (DE); Soeren Schmidt, Jena (DE); Stefan Wilhelm, Jena (DE)

(21) Appl. No.: 19/230,857

(22) Filed: Jun. 6, 2025

(30) Foreign Application Priority Data
Jun. 7, 2024 (DE) 10 2024 116 028.4

(51) Int. Cl. G02B 21/06; G02B 21/02; G02B 21/24

(52) U.S. Cl. CPC G02B 21/06; G02B 21/02; G02B 21/241

(57) ABSTRACT

A microscope for examining a sample, having a light source for providing illumination light, an illumination beam path with a microscope objective for directing the illumination light to the sample, wherein the illumination beam path has a telescope optics unit for providing a pupil plane and an intermediate image plane, a detector for detecting emission light emitted by the sample, a detection beam path with microscope objective for directing the emission light to the detector, and a control unit for controlling the light source and for evaluating measurement data from the detector. The illumination beam path has an at least partially achromatic beam-shaping unit for providing a coherent flat-top region in the near field of the beam-shaping unit, wherein the coherent flat-top region is located in the region of the intermediate image plane or a further intermediate image plane. A method of microscopy for examining a sample is described.

The current application claims the benefit of German Patent Application No. 10 2024 116 028.4, filed on 7 Jun. 2024, which is hereby incorporated by reference.

In a first aspect, the invention relates to a microscope for examining a sample, as per the preamble of claim 1. In a second aspect, the invention relates to a method of microscopy for examining a sample, as per the preamble of claim 23.

A generic microscope has at least the following constituent parts: a light source for providing illumination light for illuminating the sample, an illumination beam path with a microscope objective for directing the illumination light to the sample, wherein the illumination beam path has a telescope optics unit for providing a pupil plane and an intermediate image plane, a detector for detecting emission light emitted by the sample as a result of being irradiated with the illumination light, a detection beam path with the microscope objective or with a further microscope objective for directing the emission light to the detector, and a control unit for controlling the light source and for evaluating measurement data from the detector.

In a generic method of microscopy, at least the following method steps are carried out: directing illumination light to the sample via an illumination beam path with a microscope objective, wherein the illumination beam path comprises a telescope optics unit for providing a pupil plane and an intermediate image plane, directing emission light emitted by the sample as a result of being irradiated with the illumination light via a detection beam path with the microscope objective or with a further microscope objective to a detector, and evaluating measurement data from the detector using a control unit.

Generic microscopes and generic methods are known in many configurations and variants, for example from DE 10 2022 103 051 A1.

For many microscopy techniques, the illumination of a region in a sample plane with the most homogeneous, i.e. uniform, intensity distribution possible is desired. Such illumination modes are also referred to as flat-top illumination.

In addition, coherent illumination is often desired, especially when SLMs (spatial light modulators) are used to condition the illumination light.

In the past, numerous techniques have been developed for transforming Gaussian laser beam profiles into coherent flat-top beam profiles, with three main approaches existing for achieving homogeneous and coherent illumination.

In a first, comparatively easy to realize option, the laser beam with the Gaussian beam profile is clipped with a stop, for example a mechanical structural part or a coated optics unit, in such a way that only a near-axis region of the beam, in which the intensity distribution is substantially homogeneous, is used in the end. In one variant, a diffractive element can be used to cut out the desired beam components from the Gaussian beam to be shaped. With a wedge-shaped phase of the diffractive element, the desired components of the Gaussian beam can then be spatially separated from the undesired components [Salter]. By spatially adapting the wedge-shaped phase pattern to the Gaussian beam to be shaped, the homogenization can be increased [Nakata]. A disadvantage of these methods is that the light blocked by the stop and the light components removed by the diffractive element are lost and are no longer available for use.

A further way to achieve flat-top illumination is to redistribute the intensity distribution of a Gaussian beam through an optics unit in such a way that the desired beam profile is created at the output of this optics unit.

For example, the beam can be spatially divided and the individual pieces can be superimposed again in a smaller area by means of a focusing optics unit. This can be achieved, for example, with a microlens array (MLA). It is also possible to use reflective optics units, with one or more mirrors taking over the function of the MLA. Due to the spatial superposition of many partial beams, however, no flat wavefront, and therefore no spatial coherence can be ensured downstream of the beam-shaping module and the beam profile is more or less “speckled”.

With multimode fibers, beam shaping can be performed by light incident as Gaussian mode exciting a variety of spatial modes in the multimode fiber. Mode mixing in the fiber creates a homogeneous beam profile at the fiber end. The shape of the fiber cross section indicates the beam shape at the fiber end. The superposition of the fiber modes creates a speckled, therefore not completely homogeneous, beam profile. The light at the fiber output is usually not spatially coherent or only partially coherent. Another way to achieve homogenization is to use light guide rods (https://www.edmundoptics.de/c/light-pipes-homogenizing-rods/697/).

Shaping the intensity profile of a laser beam via a redistribution of the light power is possible both with refractive optics units, in particular using aspherical lenses, but also with diffractive components such as DOEs (DOE=diffractive optical element) or SLMs. Diffractive optics units can be designed as transmitting, e.g. with transmissive SLMs and/or transmissive DOEs, or reflecting, e.g. with LCOS SLMs (LCOS=Liquid Crystal on Silicon) and/or with reflective DOEs [Midel Photonics]. DOEs have the disadvantage that they are optimized for a specific wavelength, and are therefore monochromatic.

A phase function that must be used to drive a DOE or SLM to convert a Gaussian beam into a beam with the desired homogeneous intensity profile can be determined using the Gerchberg-Saxton algorithm. However, this algorithm has the disadvantage that the phase after beam shaping is not flat, but rather chaotic. The phase can be corrected using a second phase modulator in an optically conjugate plane [Jesacher]. In the Gerchberg-Saxton algorithm, an iterative method is used to calculate a phase pattern that generates a desired illumination pattern in the intermediate image when it is represented on a spatial light modulator in an upstream pupil plane under given illumination. Intermediate image and pupil are linked with one another by way of a Fourier transformation in a fundamentally known manner. Any pattern, including three-dimensional patterns, can be generated in principle, although the algorithm requires substantial computational effort[Ger72].

Further algorithms have been proposed for approaches that serve to reduce speckles, i.e. speckle-like deviations of the beam profile from the homogeneity, in holograms [Schmidt]. However, with a higher complexity of the algorithm, this is accompanied by a reduced light efficiency.

Finally, the term “Generalized Phase Contrast” refers to a method in which a phase pattern of the image to be imaged is generated in an intermediate image plane [Glückstad]. A common pass interferometer in which a rectangular or round phase mask (phase contrast filter) with a phase deviation of pi for the low spatial frequencies is installed in a pupil plane is then generated. The intensity profile of the image to be imaged can then be recovered from interference of the phase-shifted low spatial frequencies and non-modulated higher spatial frequencies.

Of the methods mentioned, spatially coherent beam shaping can be achieved with a spatial clipping of a laser beam, with a beam redistribution with refractive optics units and with a combination of two DOEs in conjugated Fourier planes.

Spatial coherence refers to a flat phase of the shaped beam after beam shaping. As described above, beam shaping by clipping the spatial beam profile is not usually appropriate due to high power losses.

Beam-shaping units based on beam redistribution using refractive optics units are commercially available from ADL-Optics, Berlin (product: ΠShaper; http://pishaper.com/shaper.html) and Asphericon, Jena (product: a|TopShape; https://www.asphericon.com/produkte/beamtuning/strahlformung).

It is also known to realize refractive or diffractive optics units using 3D printing methods and/or using nanostructures and/or metamaterials directly on a fiber end of a single-mode fiber. In addition to the component parts that bring about the actual beam shaping, it is also possible, by means of 3D printing methods, to print spherical and aspherical optical units that serve for collimating the shaped beam.

Known, for example, from US 2022/0308354A1, are far-field flat-top shapers, which generate an Airy-like intensity distribution, which becomes a flat-top distribution by propagation in the far field. Using a lens, the Airy beam profile can be Fourier-transformed to obtain a flat-top distribution in the focus of the lens. In contrast, a near-field flat-top shaper produces a flat-top region in the near-field, i.e. directly downstream of the beam shape optics units.

When generating a flat-top beam from a Gaussian beam using a refractive beam-shaping unit or redistributor, the optical setup can be achromatically realized at least partially, for example in the visible (VIS) spectral region [US2004264007A1, US6487022B1] when the optics units are selected appropriately. For this type of beam shaping, it is considered to be detrimental that the flat-top beam shape, unlike a Gaussian beam, is not propagation invariant due to the not fully corrected spherical phase.

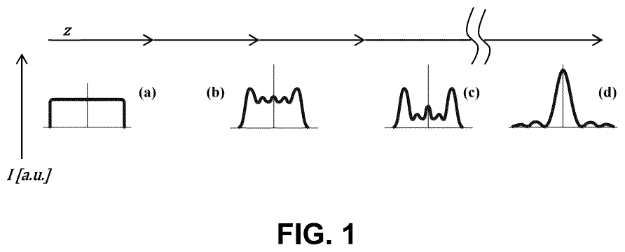

This situation is described with reference to FIG. 1 [Laskin Laskin], which shows the development of the intensity profile of the laser beam at four different axial locations along its propagation in free space. Whereas a flat-top distribution is present in the case of the situation shown in FIG. 1a, this profile changes in the course of the propagation of the laser beam in the propagation direction over the distributions in FIGS. 1b) and 1c) until ultimately in the far field in FIG. 1d) a beam distribution is present which has the shape of an Airy function, hence the Fourier transform of a flat-top profile.

The axial region downstream of the beam-shaping unit, in which the desired flat-top distribution is present and beam transformations of the kind illustrated in FIG. 1 caused by not fully corrected spherical aberration can be neglected, is 1.5 m for commercially available monochromatic beam-shaping units. However, for beam-shaping units that are achromatic in the visible (VIS) radiation range, this value is reduced to a few centimeters. As far as can be seen, no data are available yet for the optics units which are printed using 3D printing methods.

In order to be able to use the achromatic behavior of a refractive beam-shaping unit, a region of the illumination beam path in which a flat-top distribution is present has to be imaged into a region or a plane of the illumination beam path in which the flat-top illumination is intended to be applied. This can be done, for example, as described in [Laskin Laskin], using 4f telescope imaging. [Laskin] described the use of flat-top illumination to generate computer-generated holograms using LCOS and DMD (Digital Mirror Device) SLMs.

Super-resolution microscopy is a technique used to achieve a resolution that is better than the Abbe limit. In addition to the methods based on laser scanning microscopy, such as STED (Stimulated Emission Depletion) microscopy, RESOLFT (Reversible Saturable Optical Linear Fluorescence Transitions) microscopy, MINFLUX (Minimal Emission Fluxes) microscopy, Airyscan (super-resolution sampling of the detection Point Spread Function (PSF)) microscopy and ISM (Image Scanning Microscopy), there are also methods based on wide-field illumination. Relevant techniques include Structured Illumination Microscopy (SIM) and SML microscopy (SMLM=Single Molecules Localization Microscopy), which includes, for example, PALM microscopy (PALM=Photoactivated Localization Microscopy), (d) STORM-microscopy ([Direct] STochastic Optical Reconstruction Microscopy) and PAINT (Point Accumulation for Imaging in Nanoscale Topography) microscopy.

The SIM method is based on structured illumination of the sample, which is stained with suitable fluorescent dyes. It has been shown to be practical to use the orders of diffraction of a phase grating which can be generated statically or by a spatial light modulator or SLM arranged in an intermediate image plane. The orders of diffraction of the grating are imaged as points in the pupil of the microscope objective. In the sample plane, a grating structure is then formed by interference of the beams. Usually only the lowest orders of diffraction of the grating are used. Alternatively, an amplitude grating can also be imaged into the sample plane. If incoherent light is used for SIM, an amplitude grating must be used. Due to the light losses at the amplitude grating, a phase grating is preferable. Light of the +−1 and the 0 orders of diffraction of the phase grating can be imaged into the pupil of the microscope objective, wherein the illumination spots should be as small as possible. The grating structure in the illumination plane can then be generated by an interference of the +−1 and 0 orders of diffraction.

In the SMLM methods, wide-field illumination of the sample prepared with suitable fluorescent dyes is performed. Depending on the method, it is possible to initiate the blinking mechanism of the dye molecules over different wavelengths (PALM), the intensity of the illumination (dSTORM) or the sample itself (PAINT). Each blink event can be detected and the fluorescence molecule can then be localized in a computer-based manner. In addition, TIRF (Total Internal Reflection) illumination can be used to avoid background interference and/or to achieve better surface sensitivity.

An object of the invention can be considered that of specifying a microscope and a method of microscopy in which flat-top illumination is usable for different microscopy methods.

This object is achieved by means of the microscope having the features of claim 1 and by means of the method of microscopy having the features of claim 23.

Advantageous exemplary embodiments of the microscope according to the invention and preferred variants of the method according to the invention will be explained below, in particular in connection with the dependent claims and the figures.

The microscope of the abovementioned type is developed according to the invention by the illumination beam path having an at least partially achromatic beam-shaping unit for providing a coherent flat-top region in the near field of the beam-shaping unit, wherein the coherent flat-top region is located in the region of the intermediate image plane or a further intermediate image plane.

The method of the abovementioned type is developed according to the invention in that a coherent flat-top region is provided in the illumination beam path in the region of the intermediate image plane or a further intermediate image plane with an at least partially achromatic beam-shaping unit.

As a light source for the microscope according to the invention, in essence lasers are conceivable due to the coherence requirement, but other light sources are also possible. The illumination light, which can also be referred to as excitation light, is electromagnetic radiation preferably in the visible range and adjacent ranges. With regard to the samples to be examined, there is no restriction, in principle. The samples to be examined will often be biological samples.

The term illumination beam path denotes all optical beam-guiding and beam-modifying components, for example a microscope objective, lenses, mirrors, prisms, gratings, filters, stops, beam splitters, modulators, for example spatial light modulators (SLM), by means of which and via which the excitation light from the light source is guided to the sample to be examined. Beam-modifying components also encompass dispersive and in particular diffractive elements. Commercially available microscope objectives can be used, in principle.

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

When the present description mentions that a component is situated in a pupil plane or in an intermediate image plane, that is always also taken to mean that the relevant component is situated in the vicinity of the respective pupil plane or in the vicinity of the respective intermediate image plane. That is already inherently clear anyway because neither the pupil planes nor the intermediate image planes are planes in the mathematical sense and because the components under consideration here, for example the spatial light modulators and other components, each have a finite extent in the direction of the optical axis.

Emission light is electromagnetic radiation emitted by the sample illuminated with the excitation light. Emitting means that the detection light comes from the sample. The emission light can also be referred to as detection light. The emission light can be reflected back by the sample or can be light which is transmitted through the illuminated sample. The emission light can typically be, in comparison with the excitation light, red-shifted fluorescence from fluorescent markers used to prepare the sample.

Commercially available detectors can be used as detectors. Particularly preferably, semiconductor detectors are used. The detector can be in particular a two-dimensionally spatially resolving detector, i.e. a camera, for example a CCD, CMOS or SPAD array camera. However, for specific microscopy techniques, for example those in which an illumination point or an illumination line is scanned over or through the sample, it is possible to use a point-like detector, for example a photomultiplier, or a linear detector, for example a CCD or CMOS line array or a linear SPAD array.

The term detection beam path denotes all beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective of the illumination beam path and the microscope objective of the detection beam path can be one and the same microscope objective. That can be the case for reflected-light microscopy, for example, in which the sample is illuminated and observed from one and the same direction. However, the microscope objective of the illumination beam path can also differ from that of the detection beam path. That is the case for example for transmitted-light microscopy and for reflected-light microscopy in which the sample is illuminated and observed obliquely, as in light sheet microscopy, for example.

In the illumination beam path, for the purpose of varying those locations on or in the sample which are intended to be irradiated with the excitation light, a scanner can be present, for example having galvanometric mirrors or MEMS mirrors which are operated in a quasi-static or resonant fashion. Particularly preferably, the scanner mirrors are arranged in a pupil plane or in the vicinity of a pupil plane of the illumination beam path. However, a scanner is not absolutely necessary for the realization of the invention.

The term control unit denotes all hardware and software components which interact with the components of the microscope according to the invention for the intended function thereof. In particular, the control unit can comprise a computing device, for example a PC, and a camera controller. The computer resources of the control unit can be distributed among a plurality of computers and optionally a computer network, in particular also via the Internet. The control unit can have in particular customary operating devices and peripherals, such as mouse, keyboard, screen, storage media, joystick, Internet connection. The control unit can in particular read the image data from the detector and can also be configured and serve to control the light source. According to the invention, the controller is at least set up to control the light source and evaluate measurement data from the detector. If spatial light modulators are present, for example, the control unit can advantageously also be set up for controlling these light modulators. The control unit is effectively connected, for example by cables, to the components which it controls and whose measurement data it evaluates.

A coherent flat-top region is to be understood to mean a region with finite axial and finite lateral extent in the illumination beam path, in which the illumination light has a substantially homogeneous and coherent light distribution. According to the invention, the beam-shaping unit is at least partially achromatic, that is, the beam-shaping unit provides at least in a finite wavelength interval a coherent flat-top region, which, apart from the wavelength, has substantially the same properties. The beam-shaping unit may also be referred to as a beam-shaping module or a flat-top shaper.

An essential concept of the present invention can be considered the arrangement of a beam-shaping unit for providing an at least partially achromatic coherent flat-top region in an illumination beam path of the microscope for increasing the optical quality of the illumination.

A major advantage of the present invention can be considered that known microscopy methods, such as SIM microscopy and TIRF microscopy, are possible with increased quality. In particular, using the present invention, multimodal microscopes can be provided with which different microscopy methods can be carried out.

In the invention, the different at least partially achromatic beam-shaping units described above may be used for generating the coherent flat-top region. In an advantageous variant, the beam-shaping unit has refractive optics units for beam redistribution or is formed by such optics units. Preferably, the beam-shaping unit is achromatic in the range of the visible light or a partial range of the visible light. Applications of the invention are then possible for many different wavelengths of the illumination light and for many different dyes.

Furthermore, the beam-shaping unit may have a structured optical fiber or be formed by a structured optical fiber. A refractive beam shaper may be disposed at one fiber end of the optical fiber, in particular by a 3D printing method. In addition, a collimation lens may be disposed at the fiber end of the optical fiber, in particular by a 3D printing method.

For the use of the microscope according to the invention for microscopy with structured illumination (SIM), it is preferred if the beam-shaping unit is polarization-maintaining.

Upstream in front of the beam-shaping unit, a second telescope optics unit may be arranged, which serves to adapt the illumination light coming from the light source to an input aperture of the beam-shaping unit. Furthermore, the illumination beam path between the light source and the second telescope optics unit may have an optical single-mode fiber, such that the illumination light supplied to the beam-shaping unit has a Gaussian intensity profile.

The telescope optics unit may comprise a first lens and a second lens, via which 4f imaging of the back focal plane of the microscope objective or an intermediate image plane is provided. A tube lens of the illumination beam path can be part of a further telescope optics unit.

Different microscope objectives generally have different sizes of the entrance pupil. Furthermore, it is also possible that the axial positions of the entrance pupils of the respective microscope objectives are different in each case. For adapting to different sizes and/or different axial positions of the entrance pupil of different microscope objectives, it may be advantageous if the tube lens is axially adjustable.

Alternatively or in addition, the illumination beam path may have in the back focal plane of the microscope objective an adjustable collimation optics unit for adapting the illumination light. The collimation optics unit may comprise at least one axially displaceable lens, and in particular two axially displaceable lenses. Alternatively or in addition, the collimation optics unit may comprise at least one lens with adjustable focal length, and in particular two lenses with respective adjustable focal lengths. Furthermore, the collimation optics unit may alternatively or additionally comprise at least one lens changer with a plurality of lenses of different focal lengths and in particular two lens changers with a plurality of lenses of different focal lengths. Finally, it is also possible that the telescope optics unit is implemented by the collimation optics unit.

In a particularly preferred embodiment, the illumination beam path has in the region of the intermediate image plane or a further intermediate image plane a pivotable mirror for lateral displacement of illumination spots in a back focal plane of the microscope objective. A controllable actuator may be provided for pivoting the pivotable mirror, which can also be referred to as TIRF mirror.

Alternatively or in addition, the illumination beam path may have in the region of the pupil plane or a further pupil plane a linearly displaceable optics unit for generating a lateral beam offset for laterally displacing illumination spots in a back focal plane of the microscope objective. The linearly displaceable optics unit, which can also be referred to as TIRF slider, can optionally be removable from the illumination beam path. A controllable actuator may be provided for displacing the linearly displaceable optics unit.

The TIRF mirror and/or the TIRF slider may be advantageously used for TIRF microscopy and/or HILO microscopy (HILO microscopy=Highly Inclined and Laminated Optical sheet microscopy). The HILO microscopy technique is used, for example, in SML (Single Molecule Localization) microscopy.

The control unit can then be conveniently set up for controlling an actuator for pivoting the pivotable mirror and/or an actuator for displacing the linearly displaceable optics unit, in particular for carrying out TIRF and/or HILO microscopy.

The illumination light can be manipulated in the intermediate image plane or a further intermediate image plane and/or in the pupil plane or a further pupil plane of the illumination beam path for carrying out a desired microscopy method.

For the use of the microscope for microscopy with structured illumination (SIM), a wavefront modulator, in particular an adjustable one, may be present in the intermediate image plane or a further intermediate image plane. The wavefront modulator can be realized, for example, by an in particular linearly and preferably biaxially displaceable grating. Advantageously, the grating can optionally be removable from the illumination beam path. A controllable actuator can be provided for actuating, i.e. for linearly displacing, the grating. The control unit can advantageously be set up for controlling the actuator of the grating, in particular for carrying out SIM microscopy.

In a further preferred configuration, the wavefront modulator has at least one spatial light modulator.

In principle, it is possible that the spatial light modulator in the intermediate image plane or in the vicinity of an intermediate image plane and/or possibly existing further spatial light modulators is/are formed by an amplitude-modulating spatial light modulator. It is advantageous, however, if one, several or all of the spatial light modulators is or are formed by a phase-modulating spatial light modulator. Phase-modulating spatial light modulators are preferred in general owing to the smaller light losses.

Then, one, several or all of the spatial light modulators can be formed by a reflective spatial light modulator. However, it is also possible for one, several or all of the spatial light modulators to be formed by a transmissive spatial light modulator.

By way of example, one, several or all of the spatial light modulators can be formed by one or more of the following components: DMD (Digital Mirror Device), nematic SLM, LCOS display (LCOS=Liquid Crystal on Silicon), variable phase plate, actuable Deformable Mirror (DM).

Advantageously, the control unit can be set up for controlling the spatial light modulator, in particular for carrying out TIRF, HILO and/or SIM microscopy. The control unit may also be set up to control the spatial light modulator for adapting the illumination light to a variable pupil of the microscope objective. Thus, the function of the adjustable collimation optics unit described above can be realized at least partially and optionally completely such that the collimation optics unit may not be necessary.

For the purposes of SIM microscopy, the illumination beam path in the vicinity of the intermediate image plane or a further intermediate image plane can advantageously comprise a biaxially pivotable wobble plate or two respectively uniaxially pivotable wobble plates. The wobble plate or plates is/are used to displace the structuring of the illumination light for SIM microscopy that is generated by a grating and/or a spatial light modulator in the intermediate image plane. The control unit may be conveniently set up to control an actuator for biaxially pivoting the wobble plate or actuators for pivoting the uniaxial wobble plate. The actuator or actuators may, for example, be galvanometric actuators of the kind used in scanners.

In the pupil plane or a further pupil plane, a spatial light modulator may be present, which can be used, for example, for generating illumination patterns in the sample, for example for generating computer-generated holograms for illuminating the sample. The control unit may be designed to control the spatial light modulator in the pupil plane or a further pupil plane for generating illumination patterns in the sample, for example for generating a computer-generated hologram for illuminating the sample.

A preferred variant of the method according to the invention is characterized in that a spatial light modulator arranged in the intermediate image plane or a further intermediate image plane is controlled for carrying out TIRF or HILO or SIM microscopy. For TIRF microscopy or HILO microscopy, spots of the illumination light can then be suitably positioned in the back focal plane of the microscope objective using a TIRF mirror and/or a TIRF slider of the type described above such that a desired angle of incidence of the illumination light is realized in the sample.

In a further preferred variant of the method according to the invention, the coherent flat-top region is imaged into the sample and the sample is then examined with a wide-field microscopy method, for example an SMLM method.

Further advantages and features of the invention are explained below with reference to the attached drawings, in which:

FIG. 1: shows schematic diagrams explaining the properties of a coherent flat-top profile;

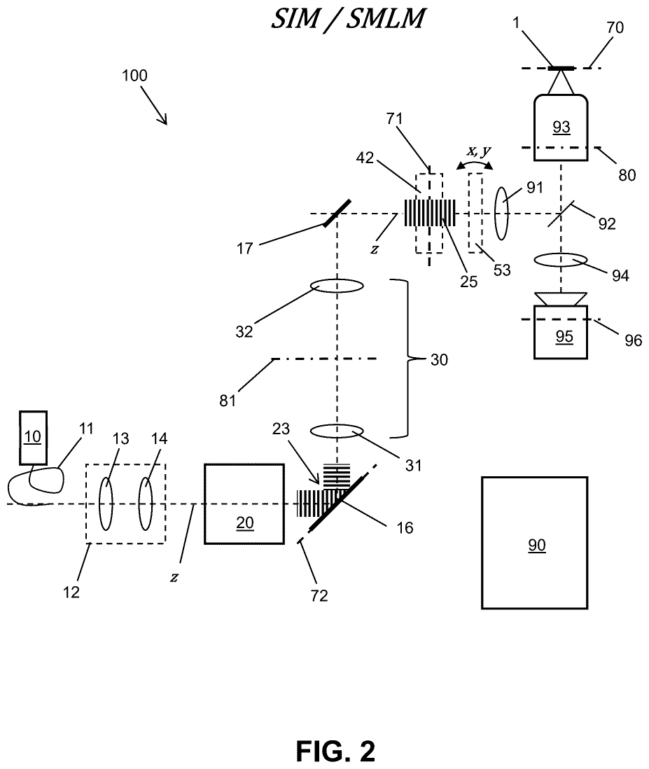

FIG. 2: shows a first exemplary embodiment of a microscope according to the invention;

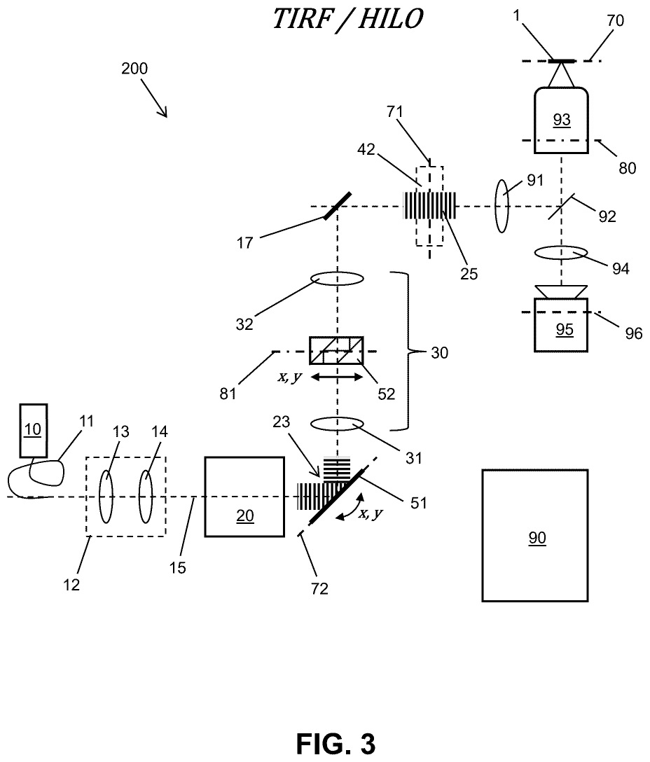

FIG. 3: shows a second exemplary embodiment of a microscope according to the invention; and

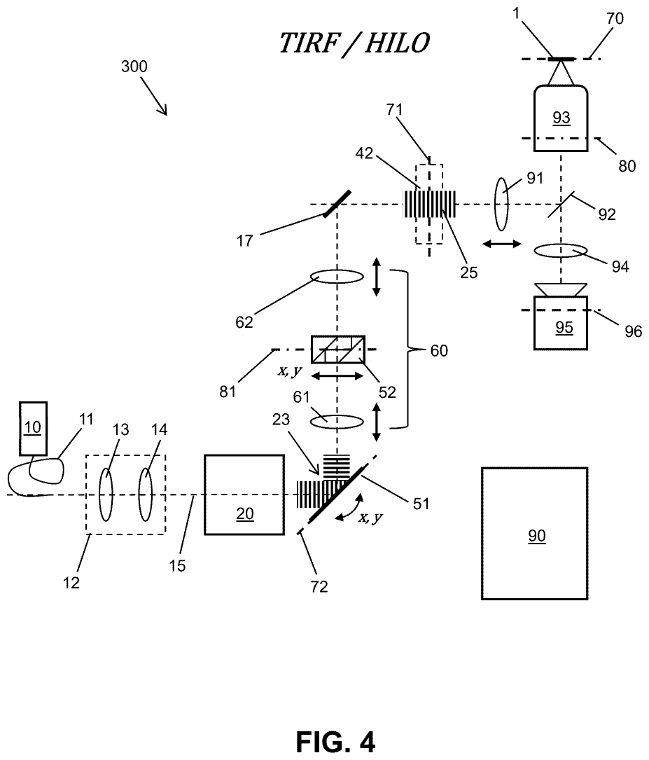

FIG. 4: shows a third exemplary embodiment of a microscope according to the invention.

Identical and identically acting components are generally provided with the same reference signs in the figures.

First, with reference to FIG. 2, a first exemplary embodiment of a microscope according to the invention for examining a sample is described. According to the invention, the microscope 100 shown in FIG. 2 first comprises a light source 10 for providing illumination light for illuminating the sample 1 and an illumination beam path with a microscope objective 93 for directing the illumination light to the sample. According to the invention, the illumination beam path further comprises a telescope optics unit 30 for providing a pupil plane 81 and an intermediate image plane 72. Furthermore, a detector 95 is present for detecting emission light, which the sample 1 emits as a result of being irradiated with the illumination light. In the exemplary embodiment shown, the microscope objective 93 is part of the detection beam path. However, it is also possible that the detection beam path has a separate microscope objective. This is the case, for example, in a setup for light sheet microscopy, in which the optical axis of the illumination beam path in the region of the sample runs transversely to the optical axis of the detection beam path. Furthermore, according to the invention, a control unit 90 for controlling the light source 10 and for evaluating measurement data from the detector 95 is present. According to the invention, the illumination beam path finally has an at least partially achromatic beam-shaping unit 20 for providing a coherent flat-top region 23 in the near field of the beam-shaping unit 20. The coherent flat-top region 23 is located in the exemplary embodiment shown in the intermediate image plane 72 provided by the telescope optics unit 30.

The telescope optics unit 30 is formed in the exemplary embodiment shown in FIG. 2 by a first lens 31 and a second lens 32. The second lens 32 is arranged at a distance relative to a tube lens 91 of the illumination beam path in such a way that a back focal plane 80 is imaged during 4f imaging into the pupil plane 81 thus provided by the telescope optics unit 30. Then, the first lens 31 is arranged upstream in the illumination beam path at a distance from the second lens 32 in such a way that an intermediate image plane 71 is imaged during 4f imaging into the intermediate image plane 72 provided by the telescope optics unit 30. The intermediate image plane 72 is the second intermediate image plane as seen from the microscope objective 93. The sample 1 is located in an object plane or sample plane 70, which is imaged via the microscope objective 93 and the tube lens 91 into the intermediate image plane 71, which is thus the first intermediate image plane as seen from the microscope objective 93.

For adjusting a beam cross section of the illumination light suitable for the beam-shaping unit 20, a second telescope optics unit 12 with a first lens 13 and a second lens 14 is present.

The exemplary embodiment, shown in FIG. 2, of the microscope 100 according to the invention is a variant which is set up for microscopy with structured illumination (SIM).

In the exemplary embodiment shown, a spatial light modulator 42, which may be, for example, a phase-modulating light modulator, for example an LCOS-SLM, is present for this purpose in the first intermediate image plane 71. However, it would also be possible that an amplitude-modulating spatial light modulator, for example a DMD (DMD=Digital Mirror Device) is used as spatial light modulator 42. In the example shown, the spatial light modulator 42 is a transmitting spatial light modulator. However, it would also be possible for the spatial light modulator 42 to be a reflective light modulator. It would also be possible to use a grating with a one-or two-dimensional spatial periodicity instead of the spatial light modulator 42.

For microscopy with structured illumination (SIM), it is necessary that an illumination grating generated by means of the spatial light modulator 42 is displaced in the sample plane 70, wherein a respective image is taken for different positions of the illumination grating in the sample 1. The individual images are then converted into an image in a generally known manner in the control unit 90. In the exemplary embodiment shown in FIG. 2, the displacement of the illumination grating necessary for this is realized by means of a two-dimensionally pivotable wobble plate 53, which is additionally mounted downstream of the spatial light modulator 42 in the vicinity of the intermediate image plane 71. The wobble plate 53 can be pivoted about the x-axis and, independently therefrom, about the y-axis. The x-axis and the y-axis form with the optical axis z running in the direction of the z-axis a right-handed rectangular coordinate system. The wobble plate 53 can be controlled, for example, with the control unit 90. For this purpose, a galvanometric drive (not shown in the figure) may be present.

In order to displace and/or rotate an illumination pattern in the sample plane 70 for microscopy with structured illumination (SIM), a mechanical displacement and/or rotation device for example for a grating arranged in the first intermediate image plane 71 may also be present instead of the wobble plate 53. A drive for such a mechanical displacement and/or rotation device can also be controlled by the control unit 90.

The illumination light supplied by the light source 10 is supplied to the second telescope optics unit 12 via an optical single-mode fiber 11 and is then brought to a suitable beam diameter by the telescope optics unit 12 and directed to the beam-shaping unit 20. The single-mode fiber 11 is not necessarily required, but may be helpful to ensure that the illumination light is supplied to the beam-shaping unit 20 as Gaussian mode. The optical axis is again labeled z. In the exemplary embodiment shown, the beam-shaping unit 12 is achromatic at least in a spectral subrange of the visible light, so that the microscope 100 can be used for many different dyes. The beam-shaping unit 20 generates, as intended, in the near region of the beam-shaping unit 20 an axially and laterally extended coherent flat-top region 23, which is located in FIG. 2 in the region of the second intermediate image plane 72 provided by the telescope optics unit 30. The flat-top region 23 is then imaged via a mirror 16, the first lens 31 and the second lens 32 of the telescope optics unit 30 and a mirror 17 via 4f imaging into a coherent flat-top region 25 in the first intermediate image plane 71, where the spatial light modulator 42 is arranged. The illumination light then passes via the wobble plate 53, the tube lens 91 and a main beam splitter 92 to the microscope 93, which directs the illumination light as intended into the object plane 70 and onto or into the sample 1.

Because the illumination light at the location of the spatial light modulator 42 is thus present in the form of the coherent flat-top region 25 and thus coherently and with a very homogeneous intensity distribution, the illumination patterns for microscopy with structured illumination (SIM) can be achieved using the spatial light modulator 42 with high precision in the object plane 70, in which the sample 1 is arranged.

As a result of the irradiation with the illumination light, the sample 1 emits emission light, which may be, for example, fluorescence light, which is red-shifted compared to the illumination light, from fluorescent dyes with which the sample 1 is prepared and which are excited by the illumination light. A portion of the emission light is directed by the microscope 93 toward the main beam splitter 92, which reflects illumination light and transmits emission light, which is red-shifted compared to the illumination light. The emission light thus passes through the main beam splitter 92 and is then imaged by a tube lens 94 in the detection beam path into an intermediate image plane 96 located in the detector 95. The detector 95 may be a two-dimensional spatially resolving detector in the exemplary embodiment shown, that is, a camera, for example, such as a CCD camera.

In the exemplary embodiment shown in FIG. 2, the control unit 90 serves at least for controlling the light source 10, the spatial light modulator 42 and the wobble plate 53 and for evaluating the measurement data from the detector 95. For this purpose, the light source 10, the spatial light modulator 42, a drive unit (not shown in the figure) of the wobble plate 53 and the camera 95 can be suitably effectively connected to the control unit 90, for example via cables (not shown in FIG. 2).

It is essential for the present invention that an at least partially achromatic beam-shaping unit 20 is present for generating the coherent flat-top region 23 and that the flat-top region 23 provided by the beam-shaping unit 20 in the near field is imaged via the telescope optics unit 30 with high optical quality into the first intermediate image plane 71 such that the structuring of the illumination light required for microscopy with structured illumination (SIM) can be carried out with high precision there using the spatial light modulator 42.

In a method alternative, in the exemplary embodiment of FIG. 2, the spatial light modulator 42 and the wobble plate 43 can be brought into a neutral position so that the coherent flat-top region 25 is imaged via the tube lens 91 and the microscope objective 93 via 4f imaging into the region of the sample plane 70. The sample 1 can then be examined with a wide-field microscopy method, for example an SML method.

In a further alternative, a spatial light modulator may be arranged in the pupil plane 81, with which spatial light modulator for example a computer-generated hologram is generated in the sample plane 70 such that, for example, only a specific region of interest of the sample 1 is illuminated.

The microscope 100 according to the invention shown in FIG. 2 implements an incident light or EPI arrangement. However, this is not necessary. In principle, the direction of illumination does not have to match the direction of observation. Transmitted-light arrangements are also possible.

A second exemplary embodiment of a microscope according to the invention for examining a sample is explained with reference to FIG. 3. The microscope 200 according to the invention shown there is set up for TIRF and/or HILO microscopy. The setup of the illumination beam path and detection beam path of the microscope 200 largely corresponds to that of the microscope 100 from FIG. 2. Only the differences are described here.

The microscope 200 in FIG. 3 differs from the microscope 100 in FIG. 2 first in that the wobble plate 53 is not present. Furthermore, in the pupil plane 81, an optics unit 52 displaceable in the lateral coordinate directions x, y is arranged, which is also referred to as a TIRF slider. In addition, instead of the mirror 16 in FIG. 2, a biaxially pivotable mirror 51 is present, which is also referred to as a TIRF mirror. The TIRF mirror 51 and/or the TIRF slider 52 are used to displace spots or points of the illumination light, i.e. illumination spots, in the back focal plane 80 of the microscope objective 93 in such a way that a desired angle of incidence of the illumination light relative to the optical axis z is realized in the sample plane 70. For practical implementations it is sufficient if either the TIRF mirror 51 or the TIRF slider 52 is present.

The illumination spots as such can be generated in a generally known manner by means of the spatial light modulator 42 in the first intermediate image plane 71. If the illumination spots in the back focal plane 80 are sufficiently far away from the optical axis z, the TIRF condition is met, and so the illumination light is totally internally reflected at a boundary surface to the sample 1. In HILO microscopy, although the TIRF condition is not met, the illumination spots in the back focal plane 80 are likewise outside the optical axis z, and so the illumination light is incident on the sample 1 at a more or less large angle relative to the optical axis z in the object plane 70.

In the microscope 200 of FIG. 3, it is also possible to examine the sample 1 using a wide-field microscopy method. For this purpose, the TIRF mirror 51, the TIRF slider 52 and the spatial light modulator 42 can be brought into their neutral positions. The beam path corresponds to that of FIG. 2 when the spatial light modulator 42 and the wobble plate 43 are brought into a neutral position there, and the coherent flat-top region 25 is imaged into the region of the sample plane 70.

A third exemplary embodiment of a microscope according to the invention for examining a sample is explained with reference to FIG. 4. The microscope 300 according to the invention shown there is again set up for TIRF and/or HILO microscopy. The setup of the illumination beam path and detection beam path of the microscope 300 largely corresponds to that of the microscope 200 from FIG. 3. Only the differences are described here. The microscope 300 according to the invention differs from the exemplary embodiment shown in FIG. 3 in that the telescope optics unit is realized by an adjustable collimation optics unit 60 having a first axially adjustable lens 61 and a second axially adjustable lens 62 and that the tube lens 91 in the illumination beam path is additionally axially adjustable. Using the axially adjustable lenses 61, 62 and 91, the illumination beam path can be adapted to different pupil sizes and different axial positions of the back focal plane 80 for different microscope objectives 93.

This allows the illumination light in the back focal plane 80 to be optimized. For example, the sizes of the illumination spots for HILO, TIRF and/or SIM microscopy in the back focal plane 80 can be reduced to a minimum.

It is also possible that in the microscopes 100 and 200 of FIGS. 2 and 3, the telescope optics unit 30 is realized by an adjustable collimation optics unit 60 with a first axially adjustable lens 61 and a second axially adjustable lens 62 and/or that the tube lens 91 in the illumination beam path is axially adjustable.

The present invention provides a novel microscope with which different super-resolution microscopy techniques, in particular SIM, SMLM, PALM, (d)STORM, PAINT, in TIRF, HILO, wide-field and/or EPI illumination regimes, are possible with the same apparatus using spatially coherent flat-top illumination. A corresponding method of microscopy is also specified.

### List of Reference Signs

1 Sample
10 Light source
11 Optical fiber, single-mode-fiber
12 Collimation optics unit, telescope optics unit
13 First lens of collimation optics unit 12
14 Second lens of collimation optics unit 12
16 Mirror, static
17 Mirror, static
20 Beam-shaping unit, beam-shaping module, flat-top shaper
23 Coherent flat-top region in intermediate image plane 72 in the near field of beam-shaping unit 20
25 Coherent flat-top region in intermediate image plane 71
30 Telescope optics unit
31 First lens of telescope optics unit 30
32 Second lens of telescope optics unit 30
42 Spatial light modulator, phase manipulator in intermediate image plane 71
51 Pivotable mirror, TIRF mirror
52 Displaceable optics unit, TIRF slider
53 Biaxially pivotable wobble plate, wobble plate pivotable about the two axes x, y that are perpendicular to the optical axis z
60 Adjustable collimation optics unit, adjustable telescope optics unit
61 First lens of telescope optics unit 60
62 Second lens of telescope optics unit 60
70 Focal plane of microscope objective 93, sample plane, object plane
71 Intermediate image plane
72 Intermediate image plane
80 Back focal plane of microscope objective 93, pupil plane
81 Pupil plane
90 Control unit
91 Tube lens in illumination beam path
92 Main beam splitter
93 Microscope objective
94 Tube lens in detection beam path
95 Detector, camera
96 Intermediate image plane in the detection beam path, in the camera 95
100 Microscope according to the invention, first exemplary embodiment
200 Microscope according to the invention, second exemplary embodiment
300 Microscope according to the invention, third exemplary embodiment
x, y Lateral coordinate directions perpendicular to each other and perpendicular to z
z Optical axis

### References

[Nakata] Yoshiki Nakata, Kazuhito Osawa, Noriaki Miyanaga, Utilization of the high spatial frequency component in adaptive beam shaping by using a virtual diagonal phase grating. Scientific Reports 9:4640 (2019)
[Jesacher] A. Jesacher, et al., Near-perfect hologram reconstruction with a spatial light modulator. OPTICS EXPRESS 2597, 16, 4 (2008)
[Schmidt] S. Schmidt, et al., Tailored micro-optical freeform holograms for integrated complex beam shaping. Optica 1279, 7, 10 (2020)
[Midel Photonics] https://midel-photonics.de/#
[Printoptix] https://www.printoptix.com/
[Plidschun] Malte Plidschun et al., Fiber-based 3D nano-printed holography with individually phase-engineered remote points. Scientific Reports 12:20920 (2022)
[Stehr] Florian Stehr, et al., Flat-top TIRF illumination boosts DNA-PAINT imaging and quantification. Nature Communications 10:1268 (2019)
[Khaw] lan Khaw, et al., Flat-field illumination for quantitative fluorescence imaging. Optics Express 26, 12 (2018)
[Glückstad] Andrew Banas and Jesper Glückstad; Light Shaping with Holography, GPC and Holo-GPC. Opt. Data Process. Storage 3:20-40 (2017)
[K2] https://ganzingerlab.github.io/K2TIRF/K2TIRF/index.html
[Power] R. M. Power, et al., Automated 3D multi-color single-molecule localization microscopy. bioRxiv
[Laskin Laskin] A. Laskin, et al., Applying field mapping refractive beam shapers to improve holographic techniques. Proc. SPIE 8281, Practical Holography XXVI: Materials and Applications, 82810K (2012)

1. A microscope for examining a sample, the microscope comprising:
a light source for providing illumination light for illuminating the sample,
an illumination beam path with a microscope objective for directing the illumination light to the sample,
wherein the illumination beam path has a telescope optics unit for providing a pupil plane and an intermediate image plane,
a detector for detecting emission light emitted by the sample as a result of being irradiated with the illumination light,
a detection beam path with the microscope objective or with a further microscope objective for directing the emission light to the detector, and
a control unit for controlling the light source and for evaluating measurement data from the detector,
wherein
the illumination beam path has an at least partially achromatic beam-shaping unit for providing a coherent flat-top region in the a near field of the beam-shaping unit, wherein the coherent flat-top region is located in a region of the intermediate image plane or a further intermediate image plane.

2. The microscope as claimed in claim 1,
wherein
the beam-shaping unit has refractive optics units for beam redistribution or is formed by refractive optics units for beam redistribution.

3. The microscope as claimed in claim 1,
wherein
the beam-shaping unit is achromatic in the a visible light range.

4. The microscope as claimed in claim 1,
wherein
the beam-shaping unit has a structured optical fiber or is formed by a structured optical fiber.

5. The microscope as claimed in claim 4,
wherein
a refractive beam shaper is disposed at one fiber end of the optical fiber.

6. The microscope as claimed in claim 1,
wherein
the beam-shaping unit is polarization-maintaining.

7. The microscope as claimed in claim 1,
wherein
a tube lens of the illumination beam path is part of a further telescope optics unit.

8. The microscope as claimed in claim 1,
wherein
a tube lens of the illumination beam path is axially adjustable.

9. The microscope as claimed in claim 1,
wherein
the illumination beam path has an adjustable collimation optics unit for adapting the illumination light in a back focal plane of the microscope objective.

10. The microscope as claimed in claim 9,
wherein
the collimation optics unit has at least one axially displaceable lens.

11. The microscope as claimed in claim 9,
wherein
the telescope optics unit is realized by the collimation optics unit.

12. The microscope as claimed in claim 1,
wherein
the illumination beam path in the region of the intermediate image plane or a further intermediate image plane has a pivotable mirror for laterally displacing illumination spots in a back focal plane of the microscope objective.

13. The microscope as claimed in claim 1,
wherein
the illumination beam path in the a region of the pupil plane or a further pupil plane has a linearly displaceable optics unit for generating a lateral beam offset for laterally displacing illumination spots in a back focal plane of the microscope objective.

14. The microscope as claimed in claim 12,
wherein
the control unit is set up for controlling an actuator for pivoting the pivotable mirror and/or an actuator for displacing the linearly displaceable optics unit.

15. The microscope as claimed in claim 1,
wherein
a wavefront modulator is present in the intermediate image plane or a further intermediate image plane.

16. The microscope as claimed in claim 15,
wherein
the wavefront modulator is realized by a displaceable grating.

17. The microscope as claimed in claim 15,
wherein
the wavefront modulator is realized by a spatial light modulator.

18. The microscope as claimed in claim 17,
wherein
the control unit is set up for controlling the spatial light modulator.

19. The microscope as claimed in claim 17,
wherein
the control unit is set up to control the spatial light modulator for adapting the illumination light to a variable pupil of the microscope objective.

20. The microscope as claimed in claim 1,
wherein
the illumination beam path for SIM microscopy has in a vicinity of the intermediate image plane or a further intermediate image plane a biaxially pivotable wobble plate or has two respectively uniaxially pivotable wobble plates.

21. The microscope as claimed in claim 20,
wherein
the control unit is set up to control an actuator for biaxially pivoting the wobble plate or actuators for pivoting the uniaxial wobble plate.

22. The microscope as claimed in claim 1,
wherein
a spatial light modulator is present in the pupil plane or a further pupil plane for generating illumination patterns in the sample.

23. A method of microscopy for examining a sample, the method comprising:
directing illumination light to the sample via an illumination beam path with a microscope objective,
wherein the illumination beam path has a telescope optics unit for providing a pupil plane and an intermediate image plane,
directing emission light emitted by the sample as a result of being irradiated with the illumination light to a detector via a detection beam path with the microscope objective or with a further microscope objective, and
a control unit evaluating measurement data from the detector,
wherein
a coherent flat-top region is provided in the illumination beam path in a region of the intermediate image plane or a further intermediate image plane with an at least partially achromatic beam-shaping unit.

24. The method as claimed in claim 23,
wherein
a spatial light modulator arranged in the intermediate image plane or a further intermediate image plane is controlled for performing TIRF or HILO or SIM microscopy.

25. The method as claimed in claim 23,
wherein
the coherent flat-top region is imaged into the sample, and
the sample is examined using a wide-field microscopy method.
